(19) United States
(12) Patent Application Publication
(10) Pub. No.: US 2025/0266913 A1
(43) Pub. Date: Aug. 21, 2025

(54) SYSTEMS AND METHODS FOR ENHANCING COVERAGE IN NON-TERRESTRIAL NETWORK (NTN)

(71) Applicant: ZTE CORPORATION, Shenzhen (CN)

(72) Inventors: Junli LI, Shenzhen (CN); Nan ZHANG, Shenzhen (CN); Wei CAO, Shenzhen (CN); Fangyu CUI, Shenzhen (CN); Yachao YIN, Shenzhen (CN)

(73) Assignee: ZTE CORPORATION, Shenzhen (CN)

(21) Appl. No.: 19/197,376

(22) Filed: May 2, 2025

Related U.S. Application Data
(63) Continuation of application No. PCT/CN2023/091462, filed on Apr. 28, 2023.

(51) Int. Cl. H04B 17/318; H04W 72/231

(52) U.S. Cl. CPC H04B 17/318; H04W 72/231

(57) ABSTRACT

Presented are systems and methods for coverage enhancement in non-terrestrial network (NTN). A wireless communication device (e.g., UE) may send a first indication to a higher layer to indicate the that poor a channel condition is poor. The higher layer can comprise at least one of: a medium access control (MAC) layer, a radio resource control (RRC) layer, an application layer, or other layer higher than a physical layer. The first indication can comprise at least one of: a measured signal strength, an indicator of signal strength, poor an indicator of that a signal is poor, or other information including the recommended position.

### CROSS-REFERENCE TO RELATED APPLICATION

This application claims the benefit of priority under 35 U.S.C. § 120 as a continuation of PCT Patent Application No. PCT/CN2023/091462, filed on Apr. 28, 2023, the disclosure of which is incorporated herein by reference in its entirety.

### TECHNICAL FIELD

The disclosure relates generally to wireless communications, including but not limited to systems and methods for coverage enhancement in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) can send/transmit/provide a first indication to a higher layer to indicate that a channel condition is poor. The higher layer can comprise at least one of: a medium access control (MAC) layer, a radio resource control (RRC) layer, an application layer, or a layer higher than a physical layer. The first indication can comprise at least one of: a measured signal strength, an indicator of signal strength, an indicator that a signal is poor, or information including a recommended position.

In some implementations, the signal can include/comprise at least one of: an uplink signal, a downlink signal, a downlink synchronization signal, and/or a master information block (MIB) signaling. In some implementations, the first indication may be sent to the higher layer by the wireless communication device if one of following conditions is satisfied: the downlink synchronization signal is not detected by the wireless communication device; the measured signal strength is lower than a configured threshold; detection of a secondary information block (SIB) has failed; detection of a MIB has failed; detection of a physical downlink control channel (PDCCH) has failed; detection of a physical downlink shared channel (PDSCH) has failed; detection attempts of the signal has reached a configured maximum number; time list information including at least one of a valid time or position is invalid; a detection window of the signal that includes a plurality of detection periods has expired; and/or indicator that the signal is poor is received from a wireless communication node.

In some implementations, sending the first indication can comprise at least one of: sending, from a lower layer of the wireless communication device, the first indication to the higher layer; sending, from a physical layer of the wireless communication device, the measured signal strength to the MAC layer; sending, from the MAC layer of the wireless communication device, the measured signal strength to the RRC layer; sending, from a RRC layer of the wireless communication device, the measured signal strength to the application layer; sending, from a physical layer of the wireless communication device, the indicator of signal strength to the MAC layer; sending, from the MAC layer of the wireless communication device, the indicator of signal strength to the RRC layer; sending, from the RRC layer of the wireless communication device, the indicator of signal strength to the application layer; sending, from the physical layer of the wireless communication device, the indicator that the signal is poor, to the MAC layer; sending, from the MAC layer of the wireless communication device, the indicator that the signal is poor, to the RRC layer; sending, from the RRC layer of the wireless communication device, the indicator that the signal is poor, to the application layer; sending, from the physical layer of the wireless communication device, the information including the recommended position, to the MAC layer; sending, from the MAC layer of the wireless communication device, the information including the recommended position, to the RRC layer; and/or sending, from the RRC layer of the wireless communication device, the information including the recommended position, to the application layer.

In some implementations, the higher layer can determine to activate a popup indication to a user of the wireless communication device by having at least one of: the higher layer activate the popup indication responsive to receiving the first indication from the lower layer of the wireless communication device; the MAC layer activate the popup indication after comparing the measured signal strength indicated in the first indication received from the physical layer of the wireless communication device, to the configured threshold; the RRC layer activate the popup indication after comparing the measured signal strength indicated in the first indication received from the MAC layer of the wireless communication device, to the configured threshold; the application layer activate the popup indication after comparing the measured signal strength indicated in the first indication received from the RRC layer of the wireless communication device, to the configured threshold; the MAC layer activate the popup indication after comparing the signal strength in the indicator indicated in the first indication received from the physical layer of the wireless communication device, to the configured threshold; the RRC layer activate the popup indication after comparing the signal strength in the indicator indicated in the first indication received from the MAC layer of the wireless communication device, to the configured threshold; the application layer activate the popup indication after comparing the signal strength in the indicator indicated in the first indication received from the RRC layer of the wireless communication device, to the configured threshold; the MAC layer activate the popup indication responsive to receiving the indication indicating that the signal is poor, from the physical layer of wireless communication device; the RRC layer activate the popup indication responsive to receiving the indication indicating that the signal is poor, from the MAC CE layer of the wireless communication device; the application layer activate the popup indication responsive to receiving the indication indicating that the signal is poor, from the RRC layer of the wireless communication device; the MAC layer activate the popup indication responsive to receiving the information including the recommended position, from the physical layer of wireless communication device; the RRC layer activate the popup indication responsive to receiving the information including the recommended position, from the MAC CE layer of the wireless communication device; and/or the application layer activate the popup indication responsive to receiving the information including the recommended position, from the RRC layer of the wireless communication device. The popup indication can comprise at least one of: an indicator of whether to move, an indicator indicating cellular coverage performance, an indicator of whether there is cellular coverage, and/or information including the recommended position.

In some implementations, the wireless communication device can send to a wireless communication node (e.g., BS, gNB, satellite, or transmission and reception point (TRP)), a second indication to report information about cellular coverage performance. The second indication can include assistance information to assist the wireless communication node in adjusting cellular coverage. In some implementations, the wireless communication device can detect/identify at least one of: a synchronization signal and/or a master information block (MIB) signal. The wireless communication device can determine, according to the detecting, whether to send the first indication to the higher layer to indicate that the channel condition is poor. The higher layer can determine, according to information in the first indication, whether to activate the popup indication.

In some implementations, the wireless communication device can determine whether to send the first indication to the higher layer to indicate that the channel condition is poor, by detecting the signal according to at least one of a threshold or a maximum number of detection attempts, wherein at least one of: the threshold can be configured for an initial access of the wireless communication device in an idle state, in a corresponding cell; the threshold can be configured via a radio resource control (RRC) signaling from the wireless communication node to the wireless communication device in a connected state; the threshold configured via the RRC signaling may be re-used; failure to detect the signal with signal strength equal to or above the configured threshold may be indicative that cellular coverage is poor; and/or failure to detect the signal with signal strength equal to or above the configured threshold, for the maximum number of detection attempts, may be indicative that cellular coverage is poor.

In some implementations, at least one of: the wireless communication device can receive/obtain/acquire, from the wireless communication node, a high layer signaling (e.g., SIB signaling, RRC signaling, MAC CE signaling, etc.) comprising time list information, wherein the time list information may be indicative of whether the wireless communication device is expected to get good or poor cellular coverage at one or more specific times or time durations or locations; the wireless communication device can determine whether to send the first indication to the higher layer to indicate that the channel condition is poor, according to the time list information; and/or the wireless communication device can provide a listing, ranking or order of the locations expected to provide good cellular coverage.

In some implementations, the wireless communication device can determine whether to send the first indication to the higher layer to indicate that the channel condition is poor, by detecting the signal according to the detection window that includes a plurality of detection periods, wherein at least one of: at least one of: the detection window and/or the plurality of detection periods, may be configured via a high layer signaling (e.g., SIB signaling, RRC signaling, MAC CE signaling, etc.) from the wireless communication node; and/or failure to detect the signal in each of the plurality of detection periods, may be indicative that cellular coverage is poor.

In some implementations, at least one of: the wireless communication device may receive at least one signaling from the wireless communication node, comprising at least one of: a third indication of a valid coverage region, communicated via a high layer signaling (e.g., SIB signaling, RRC signaling, MAC CE signaling, etc.); a fourth indication of a threshold for detection of the signal, communicated via a radio resource control (RRC) signaling; and/or determining, by the wireless communication device, to send the first indication to the higher layer to indicate that the channel condition is poor, according to at least one of: the valid coverage region being invalid; and/or the signal strength being lower than the configured threshold.

In some implementations, at least one of: the wireless communication device can receive the indication that the signal is poor from the wireless communication node, which can comprise at least one of: a fifth indication of whether to activate the first indication to the user, communicated via a control signaling; and/or a sixth indication of a trigger sequence and a correlation threshold, for detection by the wireless communication device; and/or the wireless communication device may determine whether to send the first indication to the higher layer to indicate that the channel condition is poor, according to successful detection of at least one of: the fifth indication and/or the sixth indication.

In some implementations, the fifth indication can comprise at least one bit that is added to the control signaling, and/or at least one-bit that is re-used or re-purposed in the control signaling. In some implementations, the wireless communication device can determine whether to send the first indication to the higher layer according to successful detection of the sixth indication comprises at least one of: the wireless communication device may detect the trigger sequence; the wireless communication device may determine a correlation metric of the trigger sequence; the wireless communication device may compare the correlation metric with the correlation threshold; and/or the wireless communication device may determine that cellular coverage is poor when the correlation metric is above the correlation threshold.

In some implementations, determining, by the wireless communication device, whether to send the first indication to the higher layer can comprise: the wireless communication device may receive, from a wireless communication node, another indication on whether the signal is successfully detected by the wireless communication node, wherein the another indication can include at least one of: an empty downlink control indication (DCI), and a first radio network temporary identifier (RNTI) communicated via a high layer signaling (e.g., SIB signaling, RRC signaling, MAC CE signaling, etc.) and used for scrambling the empty DCI, the empty DCI to indicate to the wireless communication device whether to send the first indication to the higher layer to indicate the poor channel condition; at least one bit configured via a high layer signaling (e.g., SIB signaling, RRC signaling, MAC CE signaling, etc.) to indicate to the wireless communication device whether to send the first indication to the higher layer to indicate the poor channel condition; and/or at least one-bit in a DCI, a second RNTI for scrambling the DCI, a time offset relative to the signal, and a frequency domain resource to be used to send the DCI, the DCI to indicate to the wireless communication device whether to send the first indication to the higher layer to indicate the poor channel condition. The wireless communication device may determine whether to send the first indication to the higher layer to indicate that the channel condition is poor, according to the another indication.

In some implementations, receiving the another indication can comprise at least one of: the wireless communication device can receive, from the wireless communication node, the another indication according to at least one of: at the time offset relative to the signal; at the frequency domain resource; within one or more defined time windows; in a DCI signaling; and/or in the high layer signaling (e.g., SIB signaling, RRC signaling, MAC CE signaling, etc.); and/or the wireless communication device may decode the another indication using the first RNTI or the second RNTI.

In some implementations, the wireless communication device may send the assistance information to the wireless communication node. The assistance information can comprise an indication of at least one of: at least one time at which the signal is successfully or unsuccessfully detected; at least one location in a cell, at which the signal is successfully or unsuccessfully detected; at least one location in multiple cells, at which the signal is successfully or unsuccessfully detected; at least one cell at which the signal is successfully or unsuccessfully detected; a number of times that the signal is successfully or unsuccessfully detected; and/or a number of popup indications that are activated.

At least one aspect is directed to a system, method, apparatus, or a computer-readable medium of the following. A higher layer can receive a first indication from a wireless communication device (e.g., UE) to indicate that a channel condition is poor. The higher layer can comprise at least one of: a medium access control (MAC) layer, a radio resource control (RRC) layer, an application layer, or a layer higher than a physical layer. The first indication can comprise at least one of: a measured signal strength, a indicator of signal strength, an indicator that a signal is poor, or information including a recommended position.

The systems and methods presented herein include a novel approach for coverage enhancement in a non-terrestrial network (NTN). Specifically, the systems and methods presented herein discuss a novel solution for improving paging channel performance for relatively low signal-to-noise ratio (SNR), including different UE RRC states. The systems and methods can provide optimize coverage based on or according to UE assistance information.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example overview of UE state transitions, in accordance with some embodiments of the present disclosure;

FIG. 5 illustrates an example timing diagram of discontinuous reception (DRX) cycles, in accordance with some embodiments of the present disclosure;

FIG. 6 illustrates an example timing diagram of transmission and reception process for DRX in CONNECTED state (CDRX), in accordance with some embodiments of the present disclosure; and

FIG. 7 illustrates a flow diagram of an example method for coverage enhancement in NTN, in accordance with an embodiment of the present disclosure.

### DETAILED DESCRIPTION

### 1. Mobile Communication Technology and Environment

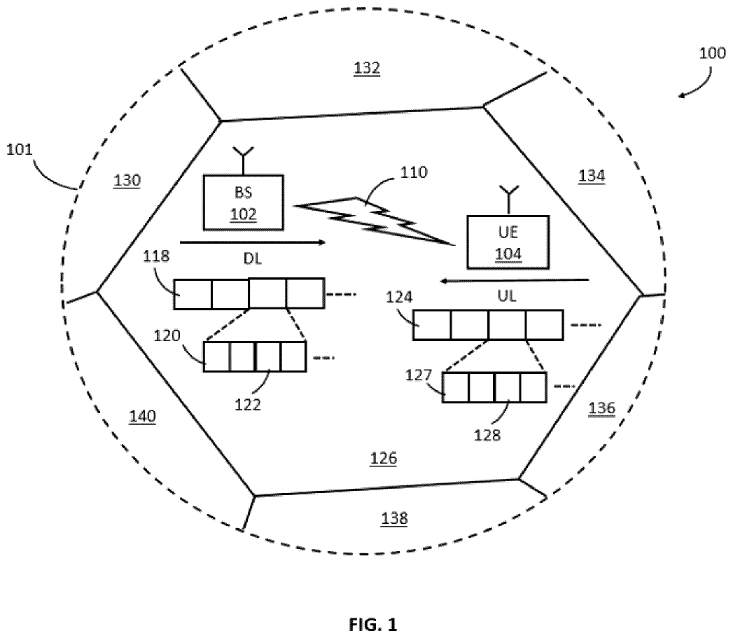

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

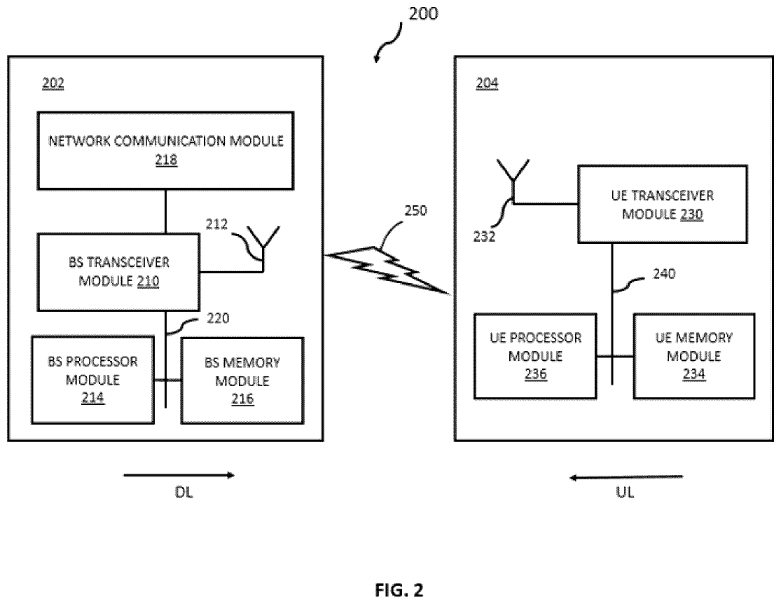

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Coverage Enhancement in NTN

In certain communication systems, sole terrestrial networks may not provide a complete/thorough communication service for all use cases (e.g., may not provide coverage for certain areas), such as geographically remote areas where terrestrial networks may not b used/utilized, and/or for certain emergency networks (e.g., islands, ships, forests, etc.). In such cases, non-terrestrial networks (NTNs) can be supported or provided for network communication. For example, satellites in the NTN can be leveraged in the field of information and communication for its wide coverage, minimal terrain impacts or obstructions, and/or independent of terrestrial network devices, stations, or components (e.g., fixed ground BS). By using NTN for communication to/with various terrestrial devices, terminals (e.g., satellite, UE 104, BS 102, etc.) may provide network connectivity at various locations for global coverage, such as for the respective mobile services.

However, in network deployment, it may be difficult/challenging to provide complete/fully seamless coverage, for instance, due to the distance between satellites (or NTN components/devices) and the UEs 104 (e.g., terrestrial devices). For example, the signals from the satellites may be blocked/obstructed/interfered with/by the atmosphere (e.g., clouds, etc.) or other objects/structures between the UEs 104 and the satellites, thereby resulting in relatively poor and/or, in some cases, disconnected communication signals.

Therefore, the systems and methods of the technical solution can provide features or operations discussed herein to improve coverage for various areas and/or to provide the popup indication for the users of the UEs 104 to timely move to areas/locations/positions with better (e.g., cellular or network) coverage, such as when the UEs 104 detect/find that they are in relatively poor or low coverage areas to achieve/obtain accurate spatiotemporal information services. Hence, the systems and methods of the technical solution discussed herein can provide features or functionalities for coverage optimization of different UE states (e.g., UE radio resource control (RRC) states) and/or coverage optimization based on UE assistance information.

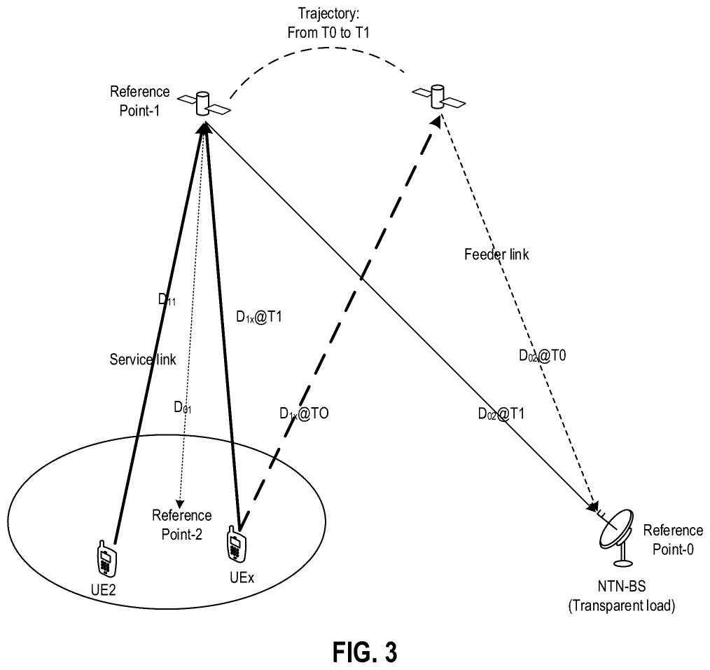

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell.

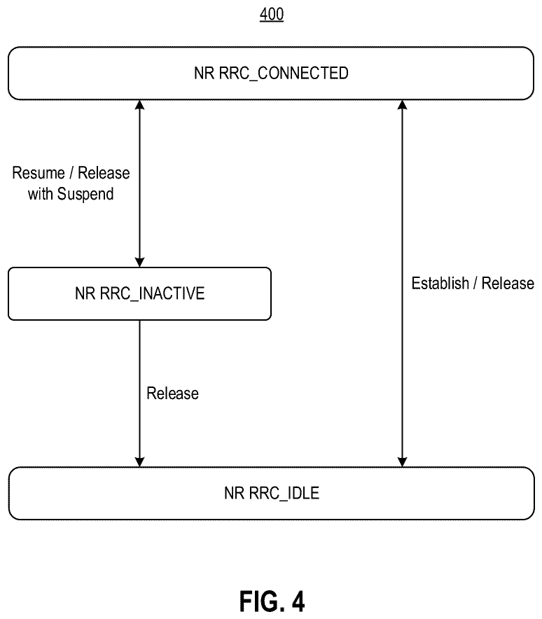

In certain networks, the UE 104 can be in an RRC_CONNECTED state or an RRC_INACTIVE state when an RRC connection is established. In some cases, if the RRC connection is not established, the UE 104 can be in the RRC_IDLE state. Referring to FIG. 4, depicted is an example overview 400 of UE state transitions, in accordance with some embodiments of the present disclosure. As shown, the example overview 400 can provide UE RRC state machine and state transitions in the communication network. The UE 104 can include or be in one RRC state/mode in the certain communication network at a time, such as RRC_CONNECTED state, RRC_INACTIVE state, or RRC_IDLE state. The RRC_INACTIVE state can be used to reduce terminal energy consumption and time delay, for example.

In some cases, data traffic can be abrupt/sudden, where the transmission can be (e.g., occasionally) active for a certain time period (e.g., relatively short/brief duration) and remain silent (e.g., not active, idle, or inactive) for other time periods (e.g., relatively long/extended duration). From a latency perspective, monitoring downlink control signaling at each time slot (or at a relatively higher frequency or more frequently) may be beneficial for receiving (e.g., improve/enhance the reception of) uplink grant and/or downlink data and/or responding to changes in the traffic behavior/characteristics. However, increasing the activity of the UE 104 (e.g., increasing the frequency of the UE 104 in RRC_CONNECTED state) can result in higher power consumption to the UE 104 (e.g., terminal). To reduce terminal power consumption, a discontinuous reception (DRX) mechanism/operation/process can be introduced.

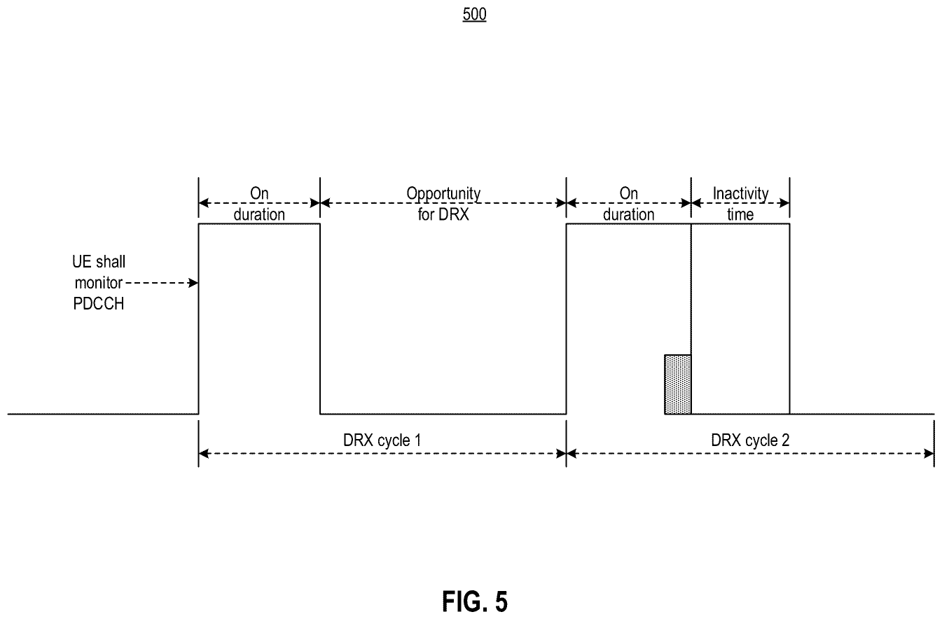

Referring to FIG. 5, depicted is an example timing diagram 500 of discontinuous reception (DRX) cycles, in accordance with some embodiments of the present disclosure. The operation or mechanism of the DRX can include configuring a DRX cycle for the terminal (e.g., UE 104). The UE 104 configured with a DRX cycle can be configured or structured/designed to monitor downlink (DL) control signaling in an active state/mode, and close or disengage the receiver circuit for the remaining time, such as to enter sleep state (e.g., inactive or idle state). A relatively longer DRX cycle can correspond to relatively lower power consumption, and vice versa. However, by reducing the duration or frequency of the UE 104 being in the active state, the scheduler may be limited because certain terminals can only be accessed during the active state of the DRX cycle. The DRX can be divided/split/separated into DRX in the IDLE state and DRX in the CONNECTED state. DRX in the IDLE state can be referred to as the “paging process”. DRX in the CONNECTED state can be referred to as “CDRX” for UEs 104 in the CDRX state. A certain DRX cycle can be shown in conjunction with FIG. 5.

For example, the “on duration” of each DRX cycle can include or correspond to a time during which the UE monitors the DL control signal subframe. During this time (e.g., on duration), the UE 104 can be in a wake-up state (e.g., active or on state) and can enter a sleep state after the duration of the wake-up state (e.g., on duration). In various cases, if an interval has been scheduled and the UE 104 is receiving/obtaining/acquiring and/or transmitting/sending/providing data/information, it may be likely for the UE 104 to be re-scheduled after a relatively short time duration. To reduce/minimize latency, the terminal (e.g., UE 104) can remain in the active state for a certain time period after being scheduled, for instance, as shown in the inactivity time in DRX cycle 2 of FIG. 5.

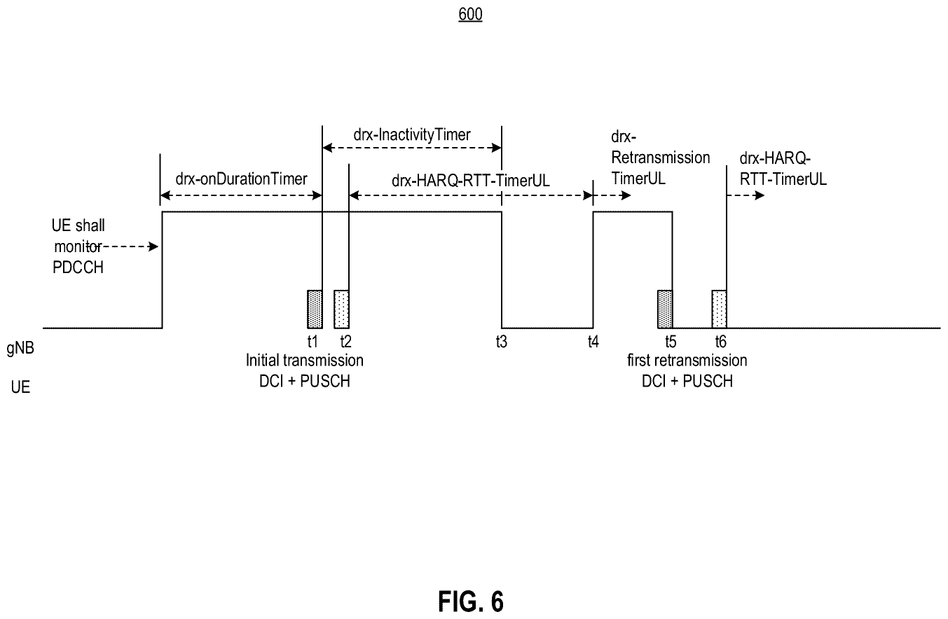

Referring to FIG. 6, depicted is an example timing diagram 600 of the transmission and reception process for DRX in CONNECTED state (CDRX), in accordance with some embodiments of the present disclosure. For CDRX, the data sending/transmission and receiving/reception process/procedure/method can be described in conjunction with FIG. 6. The process of the timing diagram 600 can include at least one of the following:
1) The drx-onDuration Timer of the UE 104 can start/initiate, and the UE 104 can start to monitor the control channel.
2) During the drx-onDuration Timer, the BS 102 sends a scheduling signal for the initial transmission of uplink (UL) process 1 at t1, and the drx-Inactivity Timer starts.
3) The UE 104 can send a UL data PUSCH to the BS 102 at t2, and start the drx-HARQ-RTT-TimerUL timer for this process (e.g., the transmission of UL data).
4) The UE 104 can stop/cancel or hault/pause the monitoring of the control channel when the drx-Inactivity Timer expires at t3.
5) At t4, drx-HARQ-RTT-TimerUL times out, and drx-RetransmissionTimerUL can start for monitoring the control channel.
6) At t5, the UE 104 can receive the first retransmission scheduling signaling sent by the BS 102 for process 1 (e.g., step 1). The drx-RetransmissionTimerUL can stop and the UE 104 can stop monitoring the control channel. The UE 104 can switch to the sleep state/mode when the UE 104 does not receive the retransmission scheduling signal after the drx-Retransmission TimerUL expires.
7) The UE 104 can send the UL PUSCH of the first retransmission schedule to the BS 102 at t6 and start the drx-HARQ-RTT-TimerUL timer for the process, such as responsive to sending the UL PUSCH. The UE 104 and/or the BS 102 may perform one or more similar or different procedures/operations/processes herein for CDRX.

In some implementations, when the UE 104 is in a relatively poor/low coverage range or area, the UE 104 may send/provide/signal/communicate/transmit an indication to a higher layer (e.g., associated with the UE 104 or one or more other devices within the network 100 or the core network) indicating that it is currently in a relatively poor coverage range (e.g., poor channel condition). The indication can include or correspond to at least one of: a measured signal strength (e.g., value representing the measured signal strength), an indicator of signal strength, a poor indicator of a signal (e.g., indicating a poor coverage range), and/or information including the recommended position for the UE 104 to reposition for improved/higher coverage range, among other information. The higher layer can include or correspond to at least one of: a medium access control (MAC) layer, a radio resource control (RRC) layer, an application layer, or other layers of the UE 104, such as layers higher than the physical layer, for example. The signal to be used for measuring the channel condition can include at least one of a downlink synchronization signal, a master information block (MIB) signaling, other downlink signals, and/or an uplink signal, etc. Accordingly, at least one of the following example implementations (e.g., at least one of example implementations 1-4) may be considered, implemented, or utilized.

### Example Implementation 1: Coverage Optimization for IDLE UE

In various implementations, the systems and methods of the technical solution discussed herein can optimize coverage for UEs 104 in the IDLE state/mode. For UEs 104 in the IDLE state, as a connection with the RRC has not been established, at least one of the following methods/operations/procedures can be considered, such as when the UE 104 is in a relatively poor/low coverage area (e.g., areas with reduced signal quality or higher transmission and/or reception interruptions):
1) When the signaling (e.g., DL synchronization signaling), such as primary synchronization signal (PSS), secondary synchronization signal (SSS), and/or synchronization signal block (SSB), can be detected, but the master information block (MIB) signal is not detected, cannot be detected, and/or decoded successfully/correctly (e.g., indicating that the current UE 104 is in a relatively weak/poor coverage with relatively poor channel conditions), the UE 104 can send an indication (e.g., first indication) to a higher layer to indicate the relatively poor channel condition (or poor coverage range), such that the higher layer can trigger an indication (e.g., a popup indication, such as a pop-up) indicating for the UE 104 (or the user of the UE 104) to move another area for improved/increased or better coverage (e.g., better cellular coverage). The popup indication can include an indicator of whether to move, an indicator indicating cellular coverage performance, an indicator of whether there is cellular coverage, and/or information including the recommended/suggested position associated with a relatively good coverage area, etc. As indicated herein, the popup indication can refer to one or various types of indications configured to provide certain information to the user or operator the respective device, such as the operator of the UE 104.
2) In some implementations, to determine whether the signal is successfully detected, the UE 104 can detect the signal according to at least one of a threshold or a maximum number of detection attempts. For example, a predefined threshold (e.g., reference signal received power (RSRP), reference signal received quality (RSRQ), and/or received signal strength indicator (RSSI), etc.) can be applied for the initial case, e.g., the case without any prior connection (e.g., RRC_CONNECTED state). In this case, the threshold can be configured for an initial access of the UE 104 in the idle state, in a corresponding cell. If there is a prior connection, when (e.g., in the process of) going back to idle, the threshold can be configured in/via the RRC release signaling, such as from the BS 102 (e.g., or satellite) to the UE 104 in the connected state. In this case, the UE 104 may reuse a value (e.g., threshold) configured via the RRC signaling.
3) In some arrangements, predefined time list information (e.g., time corresponding to satellite position) can be determined/computed/calculated (e.g., periodically) through/via satellite ephemeris information and configured to the UE 104 via the periodic high-layer signaling (e.g., SIB, etc.). The time list information can include or indicate various time durations/periods or instances when the satellite is in certain positions to provide relatively good or poor coverages for one or more respective regions/areas/locations. According to the multiple candidate regions with relatively good coverage determined by the UE 104 based on the time list information, when the signal is relatively poor, the UE 104 can send an indication (e.g., first indication) to the higher layer indicating the relatively poor channel condition, such that the higher layer can trigger or initiate the popup indication (e.g., an indicator of whether to move, etc.) for the user to move to a relatively good coverage area (e.g., provide an indication of the relatively good coverage area within the same cell or a different cell).
4) For each detection time window, one or more detection periods can be preconfigured via/by high layer signaling (e.g., SIB signaling, RRC signaling, MAC CE signaling, etc.). The detection time window can be an integer multiple of the detection period (e.g., x1, x2, etc.), where the modulus of the detection time window and the detection period can correspond to zero (e.g., the detection time window mod the detection period can be or equal to zero). When the UE 104 is not able to or cannot detect at least one or any signal from the BS 102 or satellite, the detection time window timer can be initiated/started/triggered. For example, if the UE 104 fails to receive a valid signal for multiple detection periods (e.g., periodic detections) within the detection time window and the detection time window expires, the UE 104 can determine that it is no longer within the valid/effective coverage range. In such cases, the UE 104 can send an indication to the higher layer indicating the relatively poor channel condition, such that the higher layer can trigger the popup indication for the user to move to a relatively good coverage area.
5) A threshold value “y” (e.g., can be a small value, such as RSRP) and the maximum number of times (e.g., three times, five times, etc.) for attempting detection can be (pre-) configured by high layer signaling (e.g., SIB, RRC, MAC CE, etc.). In this case, if the signal detection value is lower/less than y for at least the maximum number of consecutive times/attempts, the UE 104 can determine that it is no longer within the effective coverage range (e.g., not within the relatively good area). In such cases, the UE 104 can send an indication to the higher layer indicating the relatively poor channel condition, such that the higher layer can activate/trigger/initiate the popup indication, such as for the user to move to at least one other area that provides relatively good coverage.

In some embodiments, considering that terrestrial networks and NTN operate in different frequency bands, the methods described above in NTN can be implemented similarly using methods in the terrestrial networks, such as utilizing the predefined thresholds, defining time list information related to the beam/signal, detection time window and detection period, detection threshold and maximum detection times, etc. By measuring relevant indicators on the UE side, the UE 104 can be configured to (timely) sense whether the current channel environment provides relatively good coverage and/or move to a well-covered area (e.g., better cellular coverage area compared to the current (or previous) area/position of the UE 104) subsequent to determining that the current channel environment corresponds to a relatively poor coverage area (e.g., in timely a timely manner).

Based on the example methods/operations/procedures, the following examples can be considered for implementations by the UE 104 and the BS 102 or the satellite.

### Example 1 of Example Implementation 1

When the UE 104 detects a synchronization signaling (e.g., PSS, SSS, and/or SSB, etc.) sent by the BS 102 or the satellite, but cannot detect the MIB signal, and/or the detected MIB signal cannot be decoded correctly due to poor signal quality (e.g., in the case of example method 1 described above), the UE 104 can send an indication to the higher layer indicating the relatively poor channel condition, such that the higher layer can trigger/activate/initiate the popup indication to inform, indicate, or recommend the user (e.g., intelligent terminal holder) to move to an area with relatively good coverage. During the movement process, the UE 104 can continue to attempt to detect synchronization signaling and MIB signaling. If the MIB fails to be received correctly (e.g., failure to decode) and/or fails to be received by the UE 104, the UE 104 can maintain the popup indication (or continue to trigger/activate the popup indication) to prompt the user until the random access procedure is successful.

### Example 2 of Example Implementation 1

In some cases, if the UE 104 detects the synchronization signal and fails to detect, receive, or decode the MIB. The UE 104 can attempt to detect the signaling (e.g., synchronization signaling) when the detected threshold/metric is lower/less than a predefined/predetermined threshold (e.g., as described in conjunction with at least example method 2 hereinabove). In this case, the threshold may be a detection signal strength. For example, the received signaling can be of lower power, representing that the UE 104 is in a relatively low/weak coverage with relatively poor channel conditions. In such cases, the UE 104 can send an indication to the higher layer indicating the relatively poor channel condition, such that the higher layer can trigger/activate the popup indication indicating for the user to attempt moving to another area/location with relatively good coverage. During the movement process, the UE 104 can continue to attempt the detection of synchronization signaling and MIB signaling (e.g., continue to monitor the signalings). If the detected threshold/metric (e.g., detection signal strength) is lower than predefined threshold, the UE 104 can continue to activate or maintain the activated popup indication for the user, such as until the random access procedure is successful.

### Example 3 of Example Implementation 1

In some examples, in the connected state, the UE 104 can determine (e.g., compute/calculate) and periodically store or update the time list information of satellite motion/movement based on the periodically transmitted data from the satellite (e.g., satellite ephemeris information and/or satellite number, among other related information). When the UE 104 detects a synchronization signaling sent/transmitted/provided by/from the BS 102 or the satellite but does not detect the MIB signal, and/or the detected MIB signal cannot be decoded successfully or correctly. The UE 104 can determine (e.g., calculate) single or multiple candidate areas with relatively good coverage based on or according to the stored time list information. Subsequently, the UE 104 can rank/order/grade/list the coverage areas/locations from best/greatest/highest coverage areas to worst/lowest/least coverage areas. At the same time or simultaneously, the UE 104 may send an indication to the higher layer indicating the relatively poor channel condition, such that the higher layer can initiate/activate the popup indication indicating for the UE 104 to move to the relatively higher coverage area (e.g., if greater coverage is desired by the user), such that the user can move to one or more areas with relatively good coverage (e.g., cellular coverage) specified/indicated/provided by the popup indication. During the movement process, the UE 104 can continue to monitor or detect for synchronization signaling and MIB signaling. If the MIB cannot be received or correctly decoded, the UE 104 can continue to provide or maintain the provided popup indication until/up to when the random access procedure is successful. This example can correspond to or utilize operations as described in conjunction with example method 3 of the example implementation 1, for example.

### Example 4 of Example Implementation 1

In some implementations, the satellite (or the BS 102) can determine or calculate the time list information of satellite movement based on at least one of satellite ephemeris information, satellite number, and/or other relevant information. Subsequently, the satellite (or the BS 102) can broadcast the time list information to one or more UEs 102 in the cell (e.g., satellite cell or BS cell). The UE 104 can store the time list information. The UE 104 can update the time list information periodically or in response to receiving information related to the time list information from the BS 102 or the satellite. When the UE 104 detects a synchronization signaling provided by the BS 102 or the satellite but cannot detect the MIB signal, or the detected MIB signal cannot be decoded correctly/successfully. The UE 104 can determine single or multiple (e.g., candidate) areas/regions with relatively good coverage based on the stored time list information (eg., can include an indication of good coverage regions in an order/ranking). In such cases, the UE 104 may rank or order the areas from best to worst coverage. Simultaneously or concurrently, the UE 104 can send an indication to the higher layer indicating the relatively poor channel condition, such that the higher layer can activate the popup indication to indicate to the user to move to a relatively good coverage area. In some cases, the user may attempt to move to certain areas indicated/specified by the popup indication. During the movement process, the UE 104 can continue to monitor or detect for synchronization signaling and MIB signaling. If the MIB cannot be received or correctly decoded, the UE 104 can continue to provide or maintain the provided popup indication until/up to when the random access procedure is successful. This example can correspond to or utilize operations as described in conjunction with example method 3 of the example implementation 1, for example.

### Example 5 of Example Implementation 1

In some examples, when the UE 104 does not detect the synchronization signaling sent by the BS 102 or the satellite, the UE 104 can (e.g., implicitly) determine that the current channel environment (e.g., coverage area) is relatively poor, and/or the area may not include or provide coverage. In such cases, according to the detection time window (e.g., at least one detection window) and the detection periods (e.g., multiple detection periods for each detection window) as described herein, when the UE 104 is initiating (or about to initiate) the random access procedure, the UE 104 can start the timing from the detection time window (e.g., initially) and detect (or attempt to detect) broadcast signals in every interval periods. If the UE 104 does not detect one or more signals (e.g., synchronization signaling and/or MIB) sent by the BS 102 or the satellite when the timer expires (e.g., the timer timeout), the UE 104 can send an indication to the higher layer indicating the relatively poor channel condition, such that the higher layer can activate/trigger the popup indication to inform the user to move (or attempt to move) to at least another area with relatively good coverage. During the movement process, the UE 104 can continue monitoring or attempting to detect the signalings. If the access (e.g., random access procedure) fails after an expiration time, the UE 104 can continue to prompt, activate, or maintain the activation of the popup indication for the user to attempt to move to areas with relatively good coverage, such as until the random access procedure succeed. This example can correspond to or utilize operations as described in conjunction with at least example method 4 of the example implementation 1.

### Example 6 of Example Implementation 1

In some implementations, when the UE 104 does not detect the synchronization signaling sent by the BS 102 or the satellite, the UE 104 can determine that the current channel environment is relatively poor, and/or the area may not include or provide coverage. In this case, based on the threshold value (e.g., threshold value y as described above in conjunction with example method 5 of the example implementation 1) and the number of periodic detections (e.g., detection periods), when the UE 104 is configured to initiate the random access procedure, and if the signal threshold value detected by the UE for the predetermined maximum number of times (e.g., three consecutive times, etc.) is lower than the threshold value, the UE 104 can send an indication to the higher layer indicating the relatively poor channel condition, such that the higher layer can activate/trigger the popup indication to inform the user to move. During the movement process, the UE 104 can continue monitoring or attempting to detect the signalings. If the access (e.g., random access procedure) fails after an expiration time, the UE 104 can continue to prompt, activate, or maintain the activation of the popup indication for the user to attempt to move to areas with relatively good coverage, such as until the random access procedure succeed. This example can correspond to or utilize operations as described in conjunction with at least example method 5 of the example implementation 1.

### Example Implementation 2: Coverage Optimization for CONNECTED UE

For UEs 104 in the CONNECTED state, a connection has been established with the RRC, such that coverage-related information can be configured and/or periodically updated via the BS 102 or the satellite (e.g., provided to the UE 104). When the UE 104 is in a relatively poor coverage area, at least one of the following example methods can be considered, executed, or performed:
1) In some implementations, a valid (e.g., good) coverage area can be defined, such as determined or calculated by the satellite or the BS 102 based on the ephemeris information, satellite index, or other related information from the satellite, and the valid coverage area can be configured for various UEs 104 in the respective cell via/through SIB, RRC, and/or MAC signaling, among other types of signalings (e.g., high layer signaling), periodically or in response to receiving the information from the satellite. The UE 104 can receive, from the BS 102 or the satellite, the indication of the valid coverage area as part of a third indication, for example. The UE 104 can store and/or update the information from the satellite to obtain or determine the updated/latest coverage area information.
2) In some implementations, a DL signal detection threshold can be defined or configured, and the DL signal detection threshold can be configured for various UEs 104 in the respective cell via/through SIB, RRC, and/or MAC signaling, among other types of signaling, periodically or in response to receiving the configured or updated DL signal detection threshold. The UE 104 can receive the DL signal detection threshold (e.g., threshold for detection of the signal) via a fourth indication. The UE 104 can store and/or update the threshold to obtain an updated or latest threshold to (e.g., accurately) determine whether to activate the popup indication.
3) In some implementations, at least one bit can be reused or added in the control signal (e.g., from the BS 102 based on UL signal measurement from the UE 104) to indicate (e.g., using a fifth indication) whether the UE 104 is to send an indication to the higher layer indicating the relatively poor channel condition, such that the higher layer can activate the popup indication to indicate (or recommend/inform/suggest) to the user to move to a relatively good coverage area. For example, if 1 bit is reused, added, or occupied for the fifth indication, a ‘0’ bit can indicate that the user does not need to move (e.g., in a relatively good coverage area), and a ‘1’ bit can indicate that the UE 104 to send an indication to the higher layer indicating the relatively poor channel condition, such that the higher layer can activate the popup indication to indicate the user to move to relatively good coverage area.
4) In some implementations, a dedicated trigger sequence and/or a correlation detection threshold can be defined. The BS 102 and/or the satellite can send an indication (e.g., sixth indication) to the UE 104 to configure the UE 104 with the trigger sequence and the correlation threshold. The sequence can be a specific reference signal sequence, orthogonal sequence, etc. The UE 104 can determine whether to activate the popup indication based on the correlation detection results (e.g., comparison between a correlation metric to the correlation threshold, as discussed herein). For example, if the correlation metric is at or above the correlation threshold, the UE 104 can send an indication to the higher layer indicating the relatively poor channel condition, such that the higher layer can activate the popup indication indicating for the user to move. Otherwise, if the correlation metric is below the correlation threshold, the UE 104 can determine not to trigger or activate the popup indication (e.g., not necessary to move).

According to the example methods, one or more of the following examples may be performed, considered, or implemented.

### Example 1 of Example Implementation 2

In some examples, a valid coverage area/region can be defined to allow/enable the UE 104 to determine whether to activate the popup indication based on (e.g., by comparing) the relationship (e.g., distance, positioning, delta, or approximation) between the position of the UE 104 and the valid coverage area. For instance, the UE 104 can receive the third indication including the valid coverage region communicated from the BS 102 or the satellite via the high layer signaling. The various UEs 104 within the cell can (e.g., periodically) store the valid coverage area transmitted/provided/sent by the BS 102 or the satellite (e.g., sent periodically). The UEs 104 can update the existing stored valid coverage area or replace it with an updated valid coverage area according to the provided valid coverage area. When the UE 104 is repositioned/moved/relocated, based on the relative position relationship between its position and the valid coverage area, for instance, when it is at the edge of the valid/effective coverage area (e.g., edge of the area considered to have relatively good coverage), the UE 104 can send an indication to the higher layer indicating the relatively poor channel condition, such that the higher layer can activate the popup indication (e.g., pop-up window, haptic feedback, visual indication, audio indication, etc.) to inform the user (e.g., terminal holder) that the UE 104 about to move away from the effective coverage area. Hence, the user can relocate (or maintain position) according to the indication from the popup indication to be in the relatively good coverage area. This example can be associated with or described in conjunction with at least example method 1 of the example implementation 2.

### Example 2 of Example Implementation 2

In some examples, a DL signal detection threshold can be defined (e.g., by the BS 102 and/or the satellite) to cause the UE 104 to determine whether to send an indication to the higher layer indicating the relatively poor channel condition, such as based on the relationship between the measurement and the configured threshold. For instance, the UE 104 can receive the fourth indication including the threshold for detection of the signal communicated from the BS 102 or the satellite via RRC signaling or other types of signalings. The UEs 104 in a cell can periodically store and/or update the detection threshold configured by the BS 102 and/or the satellite. When the UE 104 moves or changes position, by measuring signals, such as SIB, etc., and when the detected signal threshold is lower/less than the threshold configured by the BS 102 or the satellite, the UE 104 can determine that the position of the UE 104 is in the relatively poor coverage area. The UE 104 can send an indication to the higher layer indicating the relatively poor channel condition, such that the higher layer can trigger or activate the popup indication to inform the user, such that the user can attempt to move according to the popup indication. This example can be associated with or described in conjunction with at least example method 2 of the example implementation 2.

### Example 3 of Example Implementation 2

In some examples, one bit in the control information can be reused or configured to indicate to the UE 104 whether to send an indication to the higher layer indicating the relatively poor channel condition (e.g., transmitting the fifth indication to the UE 104), for instance, such that the higher layer can trigger or activate the popup indication to indicate to the user to move to a relatively better coverage area. The BS 102 (or satellite) can measure or determine the performance of the UL signal. Subsequently, the BS 102 (or the satellite) can inform/indicate/notify the UE 104 of its current area coverage performance via a control message (e.g., control signaling). For example, when the signal threshold measured by the BS 102 is lower/less than a predetermined threshold, the BS 102 can inform the UE 104 by/via the control message whether to send an indication to the higher layer indicating the relatively poor channel condition. After receiving the indication from the BS 102, such as ‘1’ or ‘0’ depending on the configuration, for instance, if the indication includes a ‘1’ bit, the UE 104 can determine to send an indication to the higher layer indicating the relatively poor channel condition, such that the higher layer can activate the popup indication to inform the user to move. If the indication includes a ‘0’ bit, the UE 104 can determine that the user does not need to move (e.g., does not activate the popup indication). This example can be associated with or described in conjunction with at least example method 3 of the example implementation 2.

### Example 4 of Example Implementation 2

In some examples, one bit can be added to the control information to indicate to the UE 104 whether to send an indication to the higher layer indicating the relatively poor channel condition (e.g., transmitting the fifth indication to the UE 104). The BS 102 (or satellite) can measure or determine the performance of the UL signal. Subsequently, the BS 102 (or the satellite) can inform/indicate/notify the UE 104 of its current area coverage performance via a control message (e.g., control signaling). For example, when the signal threshold measured by the BS 102 is lower/less than a predetermined threshold, the BS 102 can inform the UE 104 by/via the control message whether to send an indication to the higher layer indicating the relatively poor channel condition. After receiving the indication from the BS 102, such as ‘l’ or ‘0’ depending on the configuration, for instance, if the indication includes a ‘1’ bit, the UE 104 can determine to send an indication to the higher layer indicating the relatively poor channel condition, such that the higher layer can activate the popup indication to inform the user to move. If the indication includes a ‘0’ bit, the UE 104 can determine that the user does not need to move (e.g., does not activate the popup indication). This example can be associated with or described in conjunction with at least example method 3 of the example implementation 2.

### Example 5 of Example Implementation 2

In some examples, a dedicated trigger sequence and correlation detection threshold can be defined or configured for the UE 104 to indicate to the UE 104 whether to send an indication to the higher layer indicating the relatively poor channel condition, such that the higher layer can trigger or activate the popup indication to inform the user to move to the relatively good coverage area according to the popup indication. The UE 104 can receive the trigger sequence and/or the correlation detection threshold via the sixth indication from the BS 102 or the satellite. The BS 102 (or satellite) can determine the performance of the uplink signal and inform the UE 104 of its current area coverage performance through/via a dedicated sequence. For example, when the signal threshold measured by the BS 102 is lower than a predetermined threshold, the BS 102 can send a dedicated sequence to the UE 104. The UE 104 can determine through correlation detection whether to send an indication to the higher layer indicating the relatively poor channel condition. For instance, if the correlation peak (e.g., highest measured correlation) is greater/higher than the configured correlation threshold (or equal to the configured correlation threshold depending on the configuration), the UE 104 can send an indication to the higher layer indicating the relatively poor channel condition, such that the higher layer can activate the popup indication, for instance, for the user to move to relatively good coverage area. Otherwise, if the correlation peak is lower than the configured threshold, the UE 104 can determine not to activate the popup indication (e.g., avoid activating or deactivate the popup indication). This example can be associated with or described in conjunction with at least example method 4 of the example implementation 2.

### Example Implementation 3: Coverage Optimization for DRX UE

For UEs 104 in the DRX state, the UE 104 may periodically, aperiodically, or responsively (e.g., according to instructions from the BS 102 or the satellite or an indication) activate and/or sleep. If the BS 102 (or the satellite) detects/identifies that the transmitted UL signal from the UE 104 has relatively poor performance and/or cannot be decoded correctly (e.g., the target signal-to-noise ratio (SNR) for correctly decoding the UL signal cannot be reached), at least one of the following example methods can be considered, performed, or implemented:
1) In some implementations, a specific radio network temporary identifier (RNTI) (e.g., wake up to move (WUM)-RNTI) can be defined. The BS 102 and/or the satellite can configure or provide the RNTI for/to the UE 104 via/by SIB, MAC, and RRC signaling, among other types of signalings. An empty DCI (e.g., multiplexing certain DCI formats, without transmitting any data to minimize resource consumption) can be defined for the UE 104, such as for the UE 104 to determine whether to send an indication to the higher layer indicating the relatively poor channel condition. The UE 104 can detect and decode the DCI (e.g., scrambled using the RNTI) within a time window, such as at least one of drx-HARQ-RTT-TimerUL, drx-RetransmissionTimerUL, drx-HARQ-RTT-TimerUL+drx-RetransmissionTimerUL, and/or the remaining available drx-InactivityTimer, etc. If the UE 104 detects (and/or decodes) the DCI within the time window, the UE 104 can determine to send an indication to the higher layer indicating the relatively poor channel condition.
2) In some implementations, one bit can be defined in the high layer signaling for the UE 104 to determine whether to send an indication to the higher layer indicating the relatively poor channel condition. The high layer signaling can include at least one of SIB, MAC, and/or RRC signaling, among others. The UE 104 can detect the signal within the time window, such as drx-HARQ-RTT-TimerUL, drx-RetransmissionTimerUL, and/or drx-HARQ-RTT-TimerUL+drx-RetransmissionTimerUL, etc.
3) In some implementations, a specific RNTI and/or time offset and/or frequency domain resource can be configured for the UE 104 via SIB, MAC, and/or RRC signaling. A DCI scrambled by the specific RNTI can be defined/configured by the BS 102 and/or the satellite, which can include a wake-up signal (e.g., occupying 1 bit) indicating whether the UE 104 is to send an indication to the higher layer indicating the relatively poor channel condition. When the BS 102 (or the satellite) detects/identifies that the transmitted UL signal from the UE 104 has relatively poor performance and/or cannot be decoded correctly, the BS 102 (or the satellite) can send the DCI at a time offset relative to the measured uplink signal and/or frequency domain resource to the UE 104, such that the UE 104 can determine whether to send an indication to the higher layer indicating the relatively poor channel condition via the DCI indication.

According to the example methods described hereinabove, the following examples may be considered for implementations.

### Example 1 of Example Implementation 3

In some examples, when the BS 102 (or the satellite) detects that the performance of the transmitted UL signal from the UE 104 is relatively poor (e.g., poor signal performance based on the signal measurement results) and/or cannot satisfy/meet the target or desired SNR, the BS 102 can inform the UE 104 via an empty DCI scrambled by a specific RNTI that the UL signal transmitted at the previous time instance does not meet the target SNR. The UE 104 can receive or detect the control information (e.g., DCI) within one or more corresponding time windows. If the UE 104 correctly decodes the empty DCI (e.g., without scheduling any data), and the UE 104 determines that the uplink signal sent at the previous time instance does not meet the target SNR, the UE 104 can determine to send an indication to the higher layer indicating the relatively poor channel condition, such that the higher layer can activate the popup indication to indicate to the user to move to the relatively good coverage area. If the UE 104 cannot decode or decodes the empty DCI incorrectly, the UE 104 can send an indication to the higher layer indicating the relatively poor channel condition, such that the higher layer can activate the popup indication to indicate/inform the user that the current channel is relatively poor for the user to move according to the popup indication (e.g., information of the popup indication) for good coverage. This example may be associated with or described in conjunction with at least the example method 1 of the example implementation 3.

### Example 2 of Example Implementation 3

In some examples, when the BS 102 (or the satellite) detects that the performance of the transmitted UL signal is poor and cannot meet the target SNR, the BS 102 can transmit/send an indication or a signal (e.g., wake-up-to-move signal) to the UE 104 via/through a high layer configuration or signaling, thereby informing the UE 104 that the UL signal sent at the previous time instance (e.g., previous moment or occurrence) does not meet the target SNR. If the UE 104 detects and/or receives the indication within a corresponding time window (e.g., a time window from the BS 102 transmitting the signal or indication), the UE 104 can send an indication to the higher layer indicating the relatively poor channel condition, such that the higher layer can activate/trigger the popup indication to inform the user of relocating to relatively good coverage area. If the UE 104 does not detect the signal (e.g., wake-up-to-move signal) and/or other valid signals within the corresponding time window, the UE 104 can send an indication to the higher layer indicating the relatively poor channel condition, such that the higher layer can activate the popup indication to inform the user that the current channel environment provides relatively poor coverage and/or for the user to move to a different area/region to obtain relatively good coverage. If the UE 104 detects a valid scheduling signal, such as a retransmission scheduling signal, within the corresponding time window, the UE 104 can retransmit the scheduling data (e.g., in this case, consistent with traditional DRX). This example may be associated with or described in conjunction with at least the example method 2 of the example implementation 3.

### Example 3 of Example Implementation 3

In some examples, the BS 102 (or the satellite) can send a high layer signaling bearer information to the UE 104 via/through RRC configuration or reconfiguration, such as a specific RNTI and/or time offset and/or frequency domain resource. When the BS 102 detects that the UL signal sent by the UE 104 has relatively poor performance and/or cannot meet the target SNR, the BS 102 can inform the UE 104 via the DCI, scrambled by/using the specific RNTI associated with the UL signal sent at the previous/prior time instance that does not satisfy the target SNR. After the UE 104 receives the indication at a certain time offset (e.g., relative to the UL signal) and/or frequency domain location, if the wake-up-to-move indication is enabled/active, the UE 104 can send an indication to the higher layer indicating the relatively poor channel condition, such that the higher layer can activate the popup indication to inform the user to move according to the popup indication for improving the network coverage. If the wake-up-to-move indication is not enabled or is disabled/inactive, the UE 104 may not send an indication (e.g., the first indication) to the higher layer (e.g., not indicating that the channel has relatively poor condition). If the UE 104 fails to decode the DCI, the UE 104 can send an indication to the higher layer indicating the relatively poor channel condition, such that the higher layer can activate the popup indication informing the user that the current channel environment is relatively poor and for the user to move according to the popup indication to obtain good coverage. This example may be associated with or described in conjunction with at least the example method 3 of the example implementation 3.

### Example Implementation 4: Coverage Optimization Based on UE Assistance Information

In various configurations, additionally or alternatively to the above-described information based on the network side (e.g., BS-side or satellite-side) configuration and/or pre-configuration that indicates to the UE 104 to move to a well-covered area, the UE 104 can assist the BS 102 and/or the satellite in re-planning (e.g., improving or updating) the coverage area through/via assistance information reported/provided/informed by the UE 104. The assistance information from the UE 104 can include, consider, or indicate at least one of the following example methods:
1) In some cases, the assistance information can define or include a list of the time, location, and/or detection (or activation or triggering) number of times when, for instance, the UE 104 failed measurement (e.g., such as the signal (e.g., DL signal) measurement is below or less than the threshold, and/or detection time window expired without the detection, etc.) occurred, an indication to the higher layer indicating the relatively poor channel condition is send and the popup indication was triggered/activated by higher layer, etc. The assistance information may include the time that the UE 104 stores the data, the location of the UE 104, and/or number of activations of the popup indication by the UE 104 in the same location.
2) In some cases, the assistance information can define (e.g., by the UE 104) or include a list of one or multiple locations within a cell, and/or a list of cells in multiple cells (e.g., list the information related to the channel conditions for each cell, where each cell can correspond to a constituent unit). In this case, the UE 104 can store or maintain the available and/or unavailable locations in a cell and/or cells in multiple cells detected by the UE 104 during the (e.g., continuous or periodic) attempts to access (e.g., random access procedure) by the UE 104.

After the UE 104 successfully accessed the network (e.g., established a connection with the BS 102 and/or the satellite), the UE 104 can report/provide/communicate/transmit/signal the assistance information including the list(s) to the BS 102 and/or core network for coverage optimization. In some cases, the base station and/or core network can trigger or instruct the 104 UE to send/provide the list information (e.g., of the assistance information) for coverage optimization for the BS 102 and/or the core network. Based on the example methods, at least one of the following examples can be considered, executed, or implemented.

### Example 1 of Example Implementation 4

In some examples, when the UE 104 detects that the performance of the transmitted DL signal is relatively poor and the detected metric (e.g., signal strength, number of failure times, etc.) is lower than the predetermined/configured threshold, the UE 104 can send an indication to the higher layer indicating the relatively poor channel condition, such that the higher layer can activate the popup indication informing the user to move to at least one other area with relatively good coverage. Simultaneously, concurrently, or responsive to activating the popup indication, the UE 104 can store the time and/or location of the current (or previous) failed measurement, such as incrementing the number of failures by one (e.g., adding 1 to the total number of failures). If multiple failures (e.g., two or more failures) occur at the same location, the location (e.g., the indication of the location) can be maintained or remain unchanged, the time can be updated to the latest failure time, and/or the number of failed measurements can be incremented. After the UE 104 successfully accesses the network (e.g., established a connection to the BS 102 and/or the satellite), the UE 104 can report the (e.g., measured) list information to the BS 102 and/or the satellite. Based on the list information reported by the UE 104, the BS 102 can determine or identify when and/or where the UE 104 is in an area with poor coverage. According to the number of measurement failures at the same location, the BS 102 can identify whether the area may be an area without coverage. For example, when the number of failures is greater than or equal to a predetermined threshold (e.g., relatively large), this can indicate that the UE 104 has performed multiple attempts at establishing a connection at different times in the same area, without being able to receive valid signals from the BS 102 or the satellite, which can indicate that the area may be a coverage blind area (e.g., area obstructed from or not reachable by the coverage range). Concurrently or simultaneously, the BS 120 can obtain the size (e.g., distance, dimension, or scale) of the relatively weak or low coverage area according to the location information from the UE 104. Based on the list information provided by the UE 104, the BS 102 can optimize the coverage area by adjusting transmission power, and/or beam, among other methods/techniques for the relatively weak coverage area, such as to provide relatively good coverage range to the area. This example may be associated with or described in conjunction with at least the example method 1 of the example implementation 4.

### Example 2 of Example Implementation 4

In some examples, if the UE 104 is active in a cell, when the UE 104 detects that the performance of the transmitted DL signal is relatively poor, the UE 104 can send an indication to the higher layer indicating the relatively poor channel condition, such that the higher layer can trigger/activate the popup indication to inform the user, for instance, to move to an area with relatively good coverage. Concurrent to the detection and/or activation, the UE 104 can store the location of where the failed measurement was obtained (e.g., location associated with the relatively poor signal measured by the UE 104). When the UE 104 detects that the performance of the transmitted DL signal is relatively good/well, the UE 104 can store an indication of the location associated with the relatively good signal area (e.g., location of the current successful measurement) to the list, for instance, as part of the list information. When the list is full and the UE 104 successfully accesses the network (e.g., establishes a connection with the BS 102 or the satellite), the UE 104 can report/provide the measured list information to the BS 102 or the satellite. The list can be full when for instance the measurement positions have been stored/filled in the list. For example, if the list can store a predetermined number of measurement positions, the list being full can indicate that the predetermined number of measurement positions has been measured and/or the information (e.g., successful or failed measurement) has been stored in the list. Based on the list information reported by the UE 104, the BS 102 can determine or identify one or more locations in the cell that has good coverage and/or locations that have poor coverage. Based on the list information provided by the UE 104, the BS 102 can optimize the coverage area by adjusting transmission power and/or beam, among other techniques/methods for coverage enhancement/optimization or extension, such that the currently weak coverage area can be in a good coverage range. This example may be associated with or described in conjunction with at least the example method 2 of the example implementation 4.

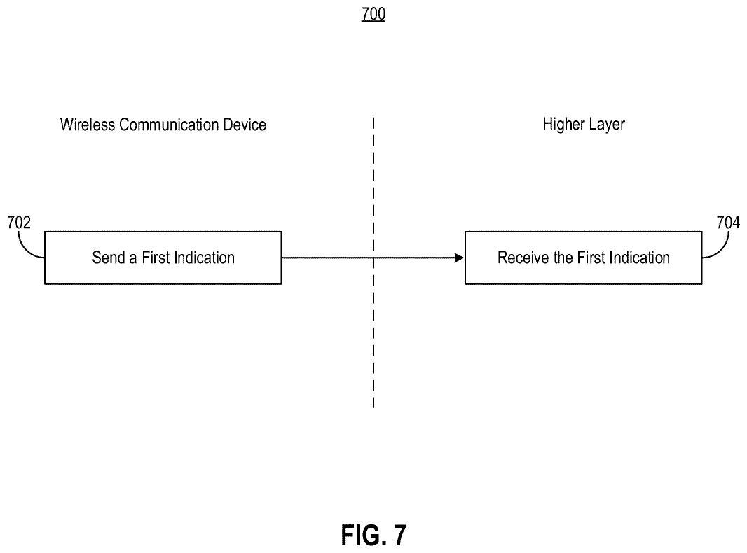

FIG. 7 illustrates a flow diagram of an example method 700 for coverage enhancement in NTN. The method 700 may be implemented using any one or more of the components and devices detailed herein in conjunction with FIGS. 1-6. In brief overview, the method 700 may be performed by at least one wireless communication device (e.g., a UE or terminal device), at least one wireless communication node (e.g., a BS, gNB, or access network equipment), at least one satellite, etc., in some embodiments. Additional, fewer, or different operations may be performed in the method 700 depending on the embodiment. At least one aspect of the operations is directed to a system, method, apparatus, or a computer-readable medium.

At operation 702, a wireless communication device can send/transmit/provide a first indication to a higher layer. At operation 704, the higher layer can receive the first indication from the wireless communication device. The first indication can indicate that a channel condition (or coverage area/location or range) is relatively poor. The first indication can include at least one of a measured signal strength, an indicator of signal strength, an indicator that a signal is poor, and/or information including a recommended position

In some cases, the wireless communication device may refer to a lower layer of the wireless communication device, such as a physical (PHY) layer, MAC CE layer, or the RRC layer. In such cases, the higher layer may include, refer to, or correspond to at least one of the MAC CE layer, RRC layer, application layer, and/or a layer relatively higher than the lower layer (e.g., higher than the physical layer) of the wireless communication device. For instance, if the lower layer refers to the MAC CE layer of the wireless communication device, the higher layer can be the RRC layer or the application layer, etc, of the wireless communication device. If the lower layer refers to the RRC layer of the wireless communication device, the higher layer may be the application layer, etc., of the wireless communication device.

In some configurations, the application layer can correspond to or be an entity (e.g., functionality entity) in a network (e.g., core network). In some other configurations, the application layer may be an application (e.g., software component) included or embedded as part of the wireless communication device, for example. In such configurations, for example, the application may receive an indication (e.g., first indication), such that the application can execute an executable code to activate or trigger an indication (e.g., popup indication) for informing the user of the wireless communication device.

In some implementations, the signal (e.g., to be measured) can include at least one of: an uplink signal, a downlink signal, a downlink synchronization signal (e.g., SSS or PSS signal), and/or a master information block (MIB) signaling.

In some implementations, the first indication may be sent to the higher layer by the wireless communication device if one of following conditions is satisfied: the downlink synchronization signal is not detected by the wireless communication device; the measured signal strength is lower than a configured threshold; detection of a secondary information block (SIB) has failed; detection of a MIB has failed; detection of a physical downlink control channel (PDCCH) has failed; detection of a physical downlink shared channel (PDSCH) has failed; detection attempts of the signal has reached a configured maximum number; time list information including at least one of a valid time or position is invalid; a detection window of the signal that includes a plurality of detection periods has expired; and/or the indicator that the signal is poor is received from a wireless communication node. In cases where the detection of the PDCCH has failed and/or when the detection of the PDSCH has failed, the wireless communication device may continue counting the failure detection. Responsive to the failure detection count reaching or detection signal strength being lower than the configured threshold, and/or detection signal strength being at or above the configured correlation threshold, and/or failure to detect the signal in the detection window that includes multiple detection periods, etc., the wireless communication device can send the indication to the higher layer.

In some implementations, to send the first indication, at least one of: a lower layer of the wireless communication device may send the first indication to the higher layer; a physical layer of the wireless communication device may send the measured signal strength to the MAC layer; the MAC layer of the wireless communication device may send the measured signal strength to the RRC layer; a RRC layer of the wireless communication device may send the measured signal strength to the application layer; a physical layer of the wireless communication device may send the indicator of signal strength to the MAC layer; the MAC layer of the wireless communication device may send the indicator of signal strength to the RRC layer; the RRC layer of the wireless communication device may send the indicator of signal strength to the application layer; the physical layer of the wireless communication device may send the indicator that the signal is poor, to the MAC layer; the MAC layer of the wireless communication device may send the indicator that the signal is poor, to the RRC layer; the RRC layer of the wireless communication device may send the indicator that the signal is poor, to the application layer; the physical layer of the wireless communication device may send the information including the recommended position, to the MAC layer; the MAC layer of the wireless communication device may send the information including the recommended position, to the RRC layer; and/or the RRC layer of the wireless communication device may send the information including the recommended position, to the application layer.

In some implementations, the higher layer can determine to activate a popup indication to a user of the wireless communication device by having at least one of: the higher layer activate the popup indication responsive to receiving the first indication from the lower layer of the wireless communication device; the MAC layer activate the popup indication after comparing the measured signal strength indicated in the first indication received from the physical layer of the wireless communication device, to the configured threshold; the RRC layer activate the popup indication after comparing the measured signal strength indicated in the first indication received from the MAC layer of the wireless communication device, to the configured threshold; the application layer activate the popup indication after comparing the measured signal strength indicated in the first indication received from the RRC layer of the wireless communication device, to the configured threshold; the MAC layer activate the popup indication after comparing the signal strength in the indicator indicated in the first indication received from the physical layer of the wireless communication device, to the configured threshold; the RRC layer activate the popup indication after comparing the signal strength in the indicator indicated in the first indication received from the MAC layer of the wireless communication device, to the configured threshold; the application layer activate the popup indication after comparing the signal strength in the indicator indicated in the first indication received from the RRC layer of the wireless communication device, to the configured threshold; the MAC layer activate the popup indication responsive to receiving the indication indicating that the signal is poor, from the physical layer of wireless communication device; the RRC layer activate the popup indication responsive to receiving the indication indicating that the signal is poor, from the MAC CE layer of the wireless communication device; the application layer activate the popup indication responsive to receiving the indication indicating that the signal is poor, from the RRC layer of the wireless communication device; the MAC layer activate the popup indication responsive to receiving the information including the recommended position, from the physical layer of wireless communication device; the RRC layer activate the popup indication responsive to receiving the information including the recommended position, from the MAC CE layer of the wireless communication device; and/or the application layer activate the popup indication responsive to receiving the information including the recommended position, from the RRC layer of the wireless communication device. The popup indication can comprise at least one of: an indicator of whether to move, an indicator indicating cellular coverage performance, an indicator of whether there is cellular coverage, and/or information including the recommended position.

In some implementations, the wireless communication device may send a second indication to report information about cellular coverage performance to a wireless communication node (e.g., BS, gNB, TRP, or satellite). The second indication can include assistance information to assist the wireless communication node in adjusting cellular coverage.

In some implementations, the wireless communication device can detect or identify at least one of: a synchronization signal and/or a master information block (MIB) signal. The wireless communication device can determine, according to the detecting, whether to send the first indication to the higher layer to indicate that the channel condition is poor. The the higher layer can determine, according to information in the first indication, whether to activate or trigger the popup indication.

In some implementations, the wireless communication device can determine whether to send the first indication to the higher layer to indicate that the channel condition is poor, by detecting the signal according to at least one of a threshold or a maximum number of detection attempts, where at least one of: the threshold may be configured for an initial access of the wireless communication device in an idle state, in a corresponding cell; the threshold may be configured via a radio resource control (RRC) signaling from the wireless communication node to the wireless communication device in a connected state; the threshold configured via the RRC signaling may be re-used; failure to detect the signal with signal strength equal to or above the configured threshold, can be indicative that cellular coverage is poor; and/or failure to detect the signal with signal strength equal to or above the configured threshold, for the maximum number of detection attempts, can be indicative that cellular coverage is poor.

In some implementations, the wireless communication device can receive/obtain/acquire a high layer signaling from the wireless communication node. The high layer signaling can comprise time list information. The time list information may be indicative of whether the wireless communication device is expected to get/obtain good or poor cellular coverage at one or more specific times or time durations or locations. In some cases, the wireless communication device can determine whether to send the first indication to the higher layer to indicate that the channel condition is poor, according to the time list information. In some cases, the the wireless communication device can provide a listing, ranking or order of the locations expected to provide good cellular coverage.

In some implementations, the wireless communication device can determine whether to send the first indication to the higher layer to indicate that the channel condition is poor, by detecting the signal according to the detection window that includes a plurality of detection periods, where at least one of: at least one of: the detection window and/or the plurality of detection periods, may be configured via a higher layer signaling from the wireless communication node; and/or failure to detect the signal in each of the plurality of detection periods, can be indicative that cellular coverage is poor.

In some implementations, at least one of: the wireless communication device can receive at least one signaling (e.g., SIB signaling, RRC signaling, MAC CE signaling, or control signal) from the wireless communication node. The at least one signal can comprise at least one of: a third indication of a valid coverage region, communicated via a higher layer signaling; a fourth indication of a threshold for detection of the signal, communicated via a radio resource control (RRC) signaling; and/or determining, by the wireless communication device, to send the first indication to the higher layer to indicate that the channel condition is poor, according to at least one of: the valid coverage region being invalid; and/or the signal strength being lower than the configured threshold.

In some implementations, the wireless communication device can receive the indication that the signal (e.g., SIB signaling, RRC signaling, MAC CE signaling, or control signal) is poor from the wireless communication node. The indication can comprise at least one of: a fifth indication of whether to activate the first indication to the user, communicated via a control signaling; and/or a sixth indication of a trigger sequence and a correlation threshold, for detection by the wireless communication device. In some cases, the wireless communication device can determine whether to send the first indication to the higher layer to indicate that the channel condition is poor, according to successful detection of at least one of: the fifth indication, and/or the sixth indication.

In some implementations, the fifth indication can comprise at least one bit that is added to the control signaling, or at least one-bit that is re-used or re-purposed in the control signaling. In some implementations, determining, by the wireless communication device, whether to send the first indication to the higher layer according to successful detection of the sixth indication may comprise at least one of: the wireless communication device may detect the trigger sequence; the wireless communication device can determine a correlation metric of the trigger sequence; the wireless communication device can compare the correlation metric with the correlation threshold; and/or the wireless communication device can determine that cellular coverage is poor when the correlation metric is at or above the correlation threshold.

In some implementations, to determine, by the wireless communication device, whether to send the first indication to the higher layer can include: the wireless communication device can receive another indication from a wireless communication node on whether the signal is successfully detected by the wireless communication node. The another indication can include at least one of: an empty downlink control indication (DCI), and a first radio network temporary identifier (RNTI) communicated via a high layer signaling and used for scrambling the empty DCI, the empty DCI to indicate to the wireless communication device whether to send the first indication to the higher layer to indicate the poor channel condition; at least one bit configured via a high layer signaling to indicate to the wireless communication device whether to send the first indication to the higher layer to indicate the poor channel condition; and/or at least one-bit in a DCI, a second RNTI for scrambling the DCI, a time offset relative to the signal, and a frequency domain resource to use to send the DCI, the DCI to indicate to the wireless communication device whether to send the first indication to the higher layer to indicate the poor channel condition. The wireless communication device can determine whether to send the first indication to the higher layer to indicate that the channel condition is poor, according to the another indication.

In some implementations, receiving the another indication can comprise at least one of: the wireless communication device may receive, from the wireless communication node, the another indication according to at least one of: at the time offset relative to the signal; at the frequency domain resource; within one or more defined time windows (e.g., drx-HARQ-RTT-TimerUL, drx-RetransmissionTimerUL, drx-HARQ-RTT-TimerUL plus drx-RetransmissionTimerUL, and/or the remaining available drx-InactivityTimer); in a DCI signaling; and/or in the high layer signaling; and/or the wireless communication device may decode the another indication using the first RNTI or the second RNTI.

In some implementations, the wireless communication device can send the assistance information to the wireless communication node. The assistance information can comprise an indication of at least one of: at least one time at which the signal is successfully or unsuccessfully detected; at least one location in a cell, at which the signal is successfully or unsuccessfully detected; at least one location in multiple cells, at which the signal is successfully or unsuccessfully detected; at least one cell at which the signal is successfully or unsuccessfully detected; a number of times that the signal is successfully or unsuccessfully detected; and/or a number of popup indications that are activated.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
sending, by a wireless communication device to a higher layer, a first indication to indicate that a channel condition is poor,
wherein the higher layer comprises at least one of: a medium access control (MAC) layer, a radio resource control (RRC) layer, an application layer, or a layer higher than a physical layer, and
wherein the first indication comprises at least one of: a measured signal strength, an indicator of signal strength, an indicator that a signal is poor, or information including a recommended position.

2. The method of claim 1, wherein the signal includes at least one of:
an uplink signal, a downlink signal, a downlink synchronization signal, or a master information block (MIB) signaling.

3. The method of claim 2, wherein the first indication is sent to the higher layer by the wireless communication device if one of following conditions is satisfied:
the downlink synchronization signal is not detected by the wireless communication device;
the measured signal strength is lower than a configured threshold;
detection of a secondary information block (SIB) has failed;
detection of a MIB has failed;
detection of a physical downlink control channel (PDCCH) has failed;
detection of a physical downlink shared channel (PDSCH) has failed;
detection attempts of the signal has reached a configured maximum number;
time list information including at least one of a valid time or position is invalid;
a detection window of the signal that includes a plurality of detection periods has expired; or
the indicator that the signal is poor is received from a wireless communication node.

4. The method of claim 3, wherein sending the first indication comprises at least one of:
sending, from a lower layer of the wireless communication device, the first indication to the higher layer;
sending, from a physical layer of the wireless communication device, the measured signal strength to the MAC layer;
sending, from the MAC layer of the wireless communication device, the measured signal strength to the RRC layer;
sending, from a RRC layer of the wireless communication device, the measured signal strength to the application layer;
sending, from a physical layer of the wireless communication device, the indicator of signal strength to the MAC layer;
sending, from the MAC layer of the wireless communication device, the indicator of signal strength to the RRC layer;
sending, from the RRC layer of the wireless communication device, the indicator of signal strength to the application layer;
sending, from the physical layer of the wireless communication device, the indicator that the signal is poor, to the MAC layer;
sending, from the MAC layer of the wireless communication device, the indicator that the signal is poor, to the RRC layer;
sending, from the RRC layer of the wireless communication device, the indicator that the signal is poor, to the application layer;
sending, from the physical layer of the wireless communication device, the information including the recommended position, to the MAC layer;
sending, from the MAC layer of the wireless communication device, the information including the recommended position, to the RRC layer; or
sending, from the RRC layer of the wireless communication device, the information including the recommended position, to the application layer.

5. The method of claim 1, comprising:
determining, by the higher layer, to activate a popup indication to a user of the wireless communication device by having at least one of:
the higher layer activate the popup indication responsive to receiving the first indication from the lower layer of the wireless communication device;
the MAC layer activate the popup indication after comparing the measured signal strength indicated in the first indication received from the physical layer of the wireless communication device, to the configured threshold;
the RRC layer activate the popup indication after comparing the measured signal strength indicated in the first indication received from the MAC layer of the wireless communication device, to the configured threshold;
the application layer activate the popup indication after comparing the measured signal strength indicated in the first indication received from the RRC layer of the wireless communication device, to the configured threshold;
the MAC layer activate the popup indication after comparing the signal strength in the indicator indicated in the first indication received from the physical layer of the wireless communication device, to the configured threshold;
the RRC layer activate the popup indication after comparing the signal strength in the indicator indicated in the first indication received from the MAC layer of the wireless communication device, to the configured threshold;
the application layer activate the popup indication after comparing the signal strength in the indicator indicated in the first indication received from the RRC layer of the wireless communication device, to the configured threshold;
the MAC layer activate the popup indication responsive to receiving the indication indicating that the signal is poor, from the physical layer of wireless communication device;
the RRC layer activate the popup indication responsive to receiving the indication indicating that the signal is poor, from the MAC CE layer of the wireless communication device;
the application layer activate the popup indication responsive to receiving the indication indicating that the signal is poor, from the RRC layer of the wireless communication device;
the MAC layer activate the popup indication responsive to receiving the information including the recommended position, from the physical layer of wireless communication device;
the RRC layer activate the popup indication responsive to receiving the information including the recommended position, from the MAC CE layer of the wireless communication device; or
the application layer activate the popup indication responsive to receiving the information including the recommended position, from the RRC layer of the wireless communication device,
wherein the popup indication comprises at least one of: an indicator of whether to move, an indicator indicating cellular coverage performance, an indicator of whether there is cellular coverage, or information including the recommended position.

6. The method of claim 1, comprising:
sending, by the wireless communication device to a wireless communication node, a second indication to report information about cellular coverage performance,
wherein the second indication includes assistance information to assist the wireless communication node in adjusting cellular coverage.

7. The method of claim 1, comprising:
detecting, by the wireless communication device, at least one of: a synchronization signal or a master information block (MIB) signal;
determining, by the wireless communication device according to the detecting, whether to send the first indication to the higher layer to indicate that the channel condition is poor; and
determining, by the higher layer according to information in the first indication, whether to activate the popup indication.

8. The method of claim 1, comprising:
determining, by the wireless communication device, whether to send the first indication to the higher layer to indicate that the channel condition is poor, by detecting the signal according to at least one of a threshold or a maximum number of detection attempts, wherein at least one of:
the threshold is configured for an initial access of the wireless communication device in an idle state, in a corresponding cell;
the threshold is configured via a radio resource control (RRC) signaling from the wireless communication node to the wireless communication device in a connected state;
the threshold configured via the RRC signaling is re-used;
failure to detect the signal with signal strength equal to or above the configured threshold, is indicative that cellular coverage is poor; or
failure to detect the signal with signal strength equal to or above the configured threshold, for the maximum number of detection attempts, is indicative that cellular coverage is poor.

9. The method of claim 1, comprising at least one of:
receiving, by the wireless communication device from the wireless communication node, a high layer signaling comprising time list information, wherein the time list information is indicative of whether the wireless communication device is expected to get good or poor cellular coverage at one or more specific times or time durations or locations;
determining, by the wireless communication device, whether to send the first indication to the higher layer to indicate that the channel condition is poor, according to the time list information; or
providing, by the wireless communication device, a listing, ranking or order of the locations expected to provide good cellular coverage.

10. The method of claim 1, comprising:
determining, by the wireless communication device, whether to send the first indication to the higher layer to indicate that the channel condition is poor, by detecting the signal according to the detection window that includes a plurality of detection periods, wherein at least one of:
at least one of: the detection window or the plurality of detection periods, is configured via a high layer signaling from the wireless communication node; or
failure to detect the signal in each of the plurality of detection periods, is indicative that cellular coverage is poor.

11. The method of claim 1, comprising at least one of:
receiving, by the wireless communication device from the wireless communication node, at least one signaling comprising at least one of:
a third indication of a valid coverage region, communicated via a high layer signaling;
a fourth indication of a threshold for detection of the signal, communicated via a radio resource control (RRC) signaling; or
determining, by the wireless communication device, to send the first indication to the higher layer to indicate that the channel condition is poor, according to at least one of:
the valid coverage region being invalid, or
the signal strength being lower than the configured threshold.

12. The method of claim 1, comprising at least one of:
receiving, by the wireless communication device from the wireless communication node, the indication that the signal is poor, which comprises at least one of:
a fifth indication of whether to activate the first indication to the user, communicated via a control signaling; or
a sixth indication of a trigger sequence and a correlation threshold, for detection by the wireless communication device; or
determining, by the wireless communication device, whether to send the first indication to the higher layer to indicate that the channel condition is poor, according to successful detection of at least one of: the fifth indication, or the sixth indication.

13. The method of claim 12, wherein the fifth indication comprises at least one bit that is added to the control signaling, or at least one-bit that is re-used or re-purposed in the control signaling.

14. The method of claim 12, wherein determining, by the wireless communication device, whether to send the first indication to the higher layer according to successful detection of the sixth indication comprises at least one of:
detecting, by the wireless communication device, the trigger sequence;
determining, by the wireless communication device, a correlation metric of the trigger sequence;
comparing, by the wireless communication device, the correlation metric with the correlation threshold; or
determining, by the wireless communication device, that cellular coverage is poor when the correlation metric is above the correlation threshold.

15. The method of claim 1, wherein determining, by the wireless communication device, whether to send the first indication to the higher layer comprises:
receiving, by the wireless communication device from a wireless communication node, another indication on whether the signal is successfully detected by the wireless communication node,
wherein the another indication includes at least one of:
an empty downlink control indication (DCI), and a first radio network temporary identifier (RNTI) communicated via a high layer signaling and used for scrambling the empty DCI, the empty DCI to indicate to the wireless communication device whether to send the first indication to the higher layer to indicate the poor channel condition;
at least one bit configured via a high layer signaling to indicate to the wireless communication device whether to send the first indication to the higher layer to indicate the poor channel condition; or
at least one-bit in a DCI, a second RNTI for scrambling the DCI, a time offset relative to the signal, and a frequency domain resource to use to send the DCI, the DCI to indicate to the wireless communication device whether to send the first indication to the higher layer to indicate the poor channel condition; and
determining, by the wireless communication device, whether to send the first indication to the higher layer to indicate that the channel condition is poor, according to the another indication.

16. The method of claim 15, wherein receiving the another indication comprises at least one of:
receiving, by the wireless communication device from the wireless communication node, the another indication according to at least one of:
at the time offset relative to the signal;
at the frequency domain resource;
within one or more defined time windows;
in a DCI signaling; or
in the high layer signaling; or
decoding, by the wireless communication device, the another indication using the first RNTI or the second RNTI.

17. The method of claim 6, comprising:
sending, by the wireless communication device to the wireless communication node, the assistance information, the assistance information comprising an indication of at least one of:
at least one time at which the signal is successfully or unsuccessfully detected;
at least one location in a cell, at which the signal is successfully or unsuccessfully detected;
at least one location in multiple cells, at which the signal is successfully or unsuccessfully detected;
at least one cell at which the signal is successfully or unsuccessfully detected;
a number of times that the signal is successfully or unsuccessfully detected; or
a number of popup indications that are activated.

18. A method comprising:
receiving, by a higher layer from a wireless communication device, a first indication to indicate that a channel condition is poor,
wherein the higher layer comprises at least one of: a medium access control (MAC) layer, a radio resource control (RRC) layer, an application layer, or a layer higher than a physical layer, and
wherein the first indication comprises at least one of: a measured signal strength, a indicator of signal strength, an indicator that a signal is poor, or information including a recommended position.

19. A wireless communication device, comprising:
at least one processor configured to:
send, via a transmitter to a higher layer, a first indication to indicate that a channel condition is poor,
wherein the higher layer comprises at least one of: a medium access control (MAC) layer, a radio resource control (RRC) layer, an application layer, or a layer higher than a physical layer, and
wherein the first indication comprises at least one of: a measured signal strength, an indicator of signal strength, an indicator that a signal is poor, or information including a recommended position.

20. A higher layer of a device, comprising:
at least one processor configured to:
receive, via a receiver from a wireless communication device, a first indication to indicate that a channel condition is poor,
wherein the higher layer comprises at least one of: a medium access control (MAC) layer, a radio resource control (RRC) layer, an application layer, or a layer higher than a physical layer, and
wherein the first indication comprises at least one of: a measured signal strength, a indicator of signal strength, an indicator that a signal is poor, or information including a recommended position.
